(19) United States
(12) Patent Application Publication
(10) Pub. No.: US 2008/0101711 A1
(43) Pub. Date: May 1, 2008

(54) Rendering engine for forming an unwarped reproduction of stored content from warped content

(76) Inventors: Antonius Kalker, Palo Alto, CA (US); Nelson Liang An Chang, Palo Alto, CA (US); Niranjan Damera-Venkata, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/586,840

(22) Filed: Oct. 26, 2006

(51) Int. Cl. G06K 9/40

(52) U.S. Cl. 382/254

(57) ABSTRACT

A rendering engine including a first component configured to render warped content that is generated remotely from the rendering engine by applying a warping transformation to stored content according to warping information and a second component configured to inversely warp the rendered warped content according to inverse warping information that corresponds to the warping information to form a reproduction of the stored content is provided. The second component is configured to inversely warp the rendered warped content subsequent to or contemporaneous with the warped content being rendered by the first component.

### BACKGROUND

Owners, creators, and distributors of visual and audio works are generally interested in preventing the works from being reproduced without authorization. These works are often stored in a digital format which may be relatively easy to copy. Digital Rights Management (DRM) or other encryption technology may be used to prevent users from being able to reproduce digital content. DRM technology generally does not alter the plaintext digital content. Accordingly, if the DRM technology is thwarted, however, users may be able to reproduce digital content. It would be desirable to be able to prevent users from being able to reproduce digital content.

### SUMMARY

According to one embodiment, a rendering engine including a first component configured to render warped content that is generated remotely from the rendering engine by applying a warping transformation to stored content according to warping information and a second component configured to inversely warp the rendered warped content according to inverse warping information that corresponds to the warping information to form a reproduction of the stored content is provided. The second component is configured to inversely warp the rendered warped content subsequent to or contemporaneous with the warped content being rendered by the first component.

### BRIEF DESCRIPTION OF THE DRAWINGS

FIG. 1A is a block diagram illustrating one embodiment of a processing system configured to generate warped content.

FIG. 1B is a block diagram illustrating one embodiment of a rendering engine produce an unwarped reproduction of stored content from warped content.

FIGS. 2A-2E are diagrams illustrating embodiments of rendering engines configured to produce an unwarped reproduction of stored content from warped content.

FIGS. 3A-3D are diagrams illustrating an example of spatially warping and spatially inverse warping visual content.

FIG. 4 is a diagram illustrating examples of warping and inverse warping audio content.

FIG. 5 is a block diagram illustrating one embodiment of a rendering engine configured to produce an unwarped reproduction of stored content from warped content.

FIGS. 6A-6D are schematic diagrams illustrating one embodiment of the projection of four sub-frames.

FIG. 7 is a diagram illustrating one embodiment of a model of an image formation process.

FIG. 8 is a diagram illustrating one embodiment of a model of an image formation process.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

As described herein, a system and method for providing security to visual and/or audio works is provided. The system and method contemplate warping the content of a visual and/or audio work with a defined distortion pattern and providing the only warped content to a rendering engine with an inverse warping component. Inverse warping information may also be provided to the rendering engine to configure the inverse warping component in one or more embodiments. The inverse warping component inversely warps the warped content as part of the rendering process to reproduce the original content without visual or acoustic distortion from the defined distortion pattern. If a rendering engine without an inverse warping component attempts to render the warped content, the defined distortion pattern is present in the reproduction.

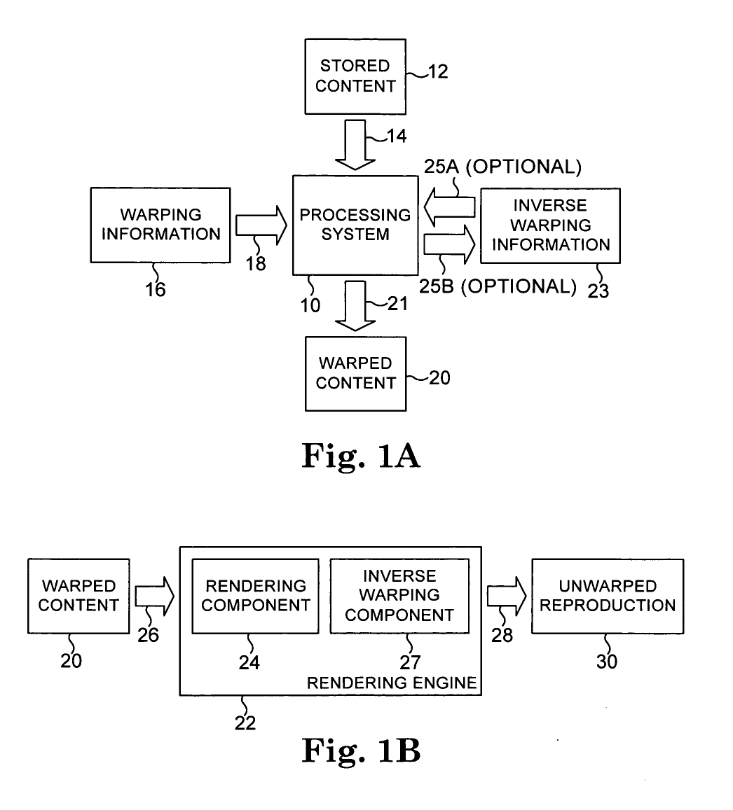

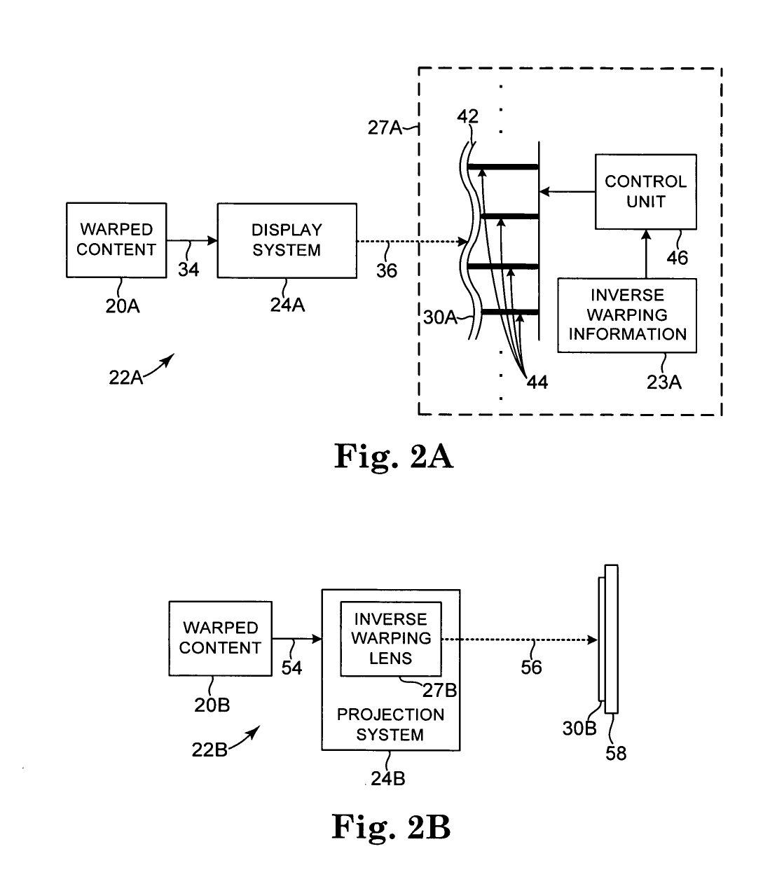

FIG. 1A is a block diagram illustrating one embodiment of a processing system 10 configured to generate warped content 20 from stored content 12 using warping information 16, and FIG. 1B is a block diagram illustrating one embodiment of rendering engine 22 configured to produce an unwarped reproduction 30 of stored content 12 from warped content 20.

Referring to FIG. 1A, processing system 10 receives stored content 12 as indicated by an arrow 14. Stored content 12 represents any type of visual, audio, or audiovisual information stored in any suitable digital plaintext format. Stored content 12 may be used by a rendering engine to reproduce one or more still or video images, audio, or a combination of images and audio. Stored content 12 may include all or a portion of a visual and/or audio work. With visual works, stored content 12 may include a movie or other video, a portion of a movie or other video, a set of one or more images, or other displayable material. With audio works, stored content 12 may include a song, a sound, an audio clip, or other reproducible audio material.

Processing system 10 also receives warping information 16 as indicated by an arrow 18. Warping information 16 is configured to be usable by processing system 10 to warp stored content 12 with spatial, visual, temporal, or amplitude distortion to generate warped content 20. Warping information 16 corresponds to an inverse warping component 27 (shown in FIG. 1B) of a rendering engine 22 (shown in FIG. 1B).

Stored content 12 and warping information 16 may be received or accessed by processing system 10 from any suitable storage device or devices (not shown). The storage devices may be portable or non-portable and may be directly connected to processing system 10, connected to processing system 10 through any number of intermediate devices (not shown), or may be remotely located from processing system 10 across one or more local, regional, or global communication networks such as the Internet (not shown).

Processing system 10 generates warped content 20 from stored content 12 using warping information 16 as indicated by an arrow 21. Processing system 10 applies a warping transformation to stored content 12 according to warping information 16. Processing system 10 generates warped content 20 such that warped content 20 may be used by rendering engine 22 to reproduce stored content 12 without distortion only by using inverse warping component 27. As described in additional detail below with reference to FIG. 1B, inverse warping component 27 inversely warps warped content 20 to reproduce stored content 12 without visual or acoustic distortion from warping information 16. When used by a rendering engine that does not include inverse warping component 27, warped content 20 produces a reproduction of stored content 12 with a defined distortion pattern from warping information 16.

Processing system 10 uses warping information 16 to visually and/or acoustically warp stored content 12 to generate warped content 20. As a result, warped content 20 includes a defined visual and/or acoustic distortion pattern when reproduced using a rendering engine without an inverse warping component that corresponds to warping information 16. The defined distortion pattern results in a degraded or lower quality reproduction where a viewer or listener can see any visual distortion and hear any acoustic distortion. Warping information 16 specifies one or more warping parameters (also referred to as degrees of freedom) that may be used by processing system to include the defined distortion pattern in warped content 20. The warping parameters cause the defined distortion pattern to occur spatially and/or temporally in the reproduction.

For visual stored content 12, processing system 10 may warp stored content 12 by configuring warped content 20 using warping information 16 such that the display of warped content 20, without inverse warping, appears with spatial distortions (e.g., stretched, compressed, or otherwise deformed displayed images). Processing system 10 may also warp visual stored content 12 by configuring warped content 20 using warping information 16 such that the display of warped content 20, without inverse warping, appears with color or light amplitude distortions (e.g., overly bright and/or overly dark regions in displayed image).

For audio stored content 12, processing system 10 may warp stored content 12 by configuring warped content 20 using warping information 16 such that the generation of audio from warped content 20, without inverse warping, includes temporal distortion (e.g., compressed, expanded, or otherwise time altered audio). Processing system 10 may also warp audio stored content 12 by configuring warped content 20 using warping information 16 such that the generation of audio from warped content 20, without inverse warping, includes sound amplitude distortion (e.g., overly loud or soft periods in the audio).

As noted above, stored content 12 may be all or a part of a visual or audio work. Processing system 10 may generate warped content 20 using different warping parameters from warping information 16 for different parts of stored content 12 (e.g., a first warping parameter for a first portion of stored content 12 (e.g., the first half of a movie) and a second warping parameter for a second portion of stored content 12 (e.g., the second half of a movie)). Processing system 10 may also generate warped content 20 using different warping information 16 for different stored content 12 (e.g., first warping information 16 for first stored content 12 (e.g., a first movie) and second warping information 16 for second stored content 12 (e.g., a second movie)).

In one embodiment, processing system 10 receives inverse warping information 23 as indicated by an arrow 25A and generates warping information 16 from inverse warping information 23 prior to generating warped content 20. Inverse warping information 23 may directly indicate the configuration of inverse warping component 27 or may indirectly indicate the configuration of inverse warping component 27 using a model or serial number of rendering engine 22 or inverse warping component 27. Processing system 10 generates warping information 16 using the configuration described by inverse warping information 23 in this embodiment. In one embodiment, an owner or user of rendering engine 22 may provide inverse warping information 23 to processing system 10 to describe a configuration of inverse warping component 27. In another embodiment, a manufacturer of rendering engine 22 or inverse warping component 27 provides inverse warping information 23 to processing system 10 to describe a configuration of inverse warping component 27.

Inverse warping information 23 may be accessed by processing system 10 from any suitable storage device or devices (not shown). The storage devices may be portable or non-portable and may be directly connected to processing system 10, connected to processing system 10 through any number of intermediate devices (not shown), or may be remotely located from processing system 10 across one or more local, regional, or global communication networks such as the Internet (not shown).

In another embodiment, processing system 10 generates inverse warping information 23 from warping information 16 as indicated by an arrow 25B and provides inverse warping information 23 to rendering engine 22. Because warping information 16 defines the warping parameters used to generate warped content 20, processing system 10 may also generate inverse warping information 23 to indicate the configuration of inverse warping component 27 in rendering engine that will allow warped content 20 to be reproduced without distortion. As described in additional detail below with reference to FIG. 1B, inverse warping component 27 may be dynamically configured to reproduce warped content 20 in response to receiving inverse warping component 27. For example, a movie studio may generate inverse warping information 23 and provide inverse warping information 23 along with warped content 20 (e.g., a warped movie) to a theater owner to allow the theater owner to configure inverse warping component 27 (e.g., a screen or lens) of rendering engine 22 (e.g., a projection system) for display of the movie.

Warped content 20 and, optionally, inverse warping information 23 are provided to rendering engine 22 (shown in FIG. 11B) in any suitable way. Rendering engine 22 is located remotely from processing system 10, and stored content 20 is not received or otherwise accessible to rendering engine 22. In one embodiment, processing system 10 couples to a local, region, or global communications network (not shown) and transmits warped content 20 across the network to rendering engine 22. In other embodiments, processing system 10 stores warped content 20 on portable media to allow warped content 20 to be physically transported to rendering engine 22.

Processing system 10 may include any suitable combination of hardware and software components. For example, processing system 10 may include one or more software components configured to be executed by the processing system 10. Any software components may be stored in any suitable portable or non-portable media that is accessible to processing system 10 either from within processing system 10 or from a storage device connected directly or indirectly (e.g., across a network) to processing system 10.

FIG. 1B is a block diagram illustrating one embodiment of rendering engine 22 configured to produce unwarped reproduction 30 of stored content 12 from warped content 20.

Rendering engine 22 receives warped content 20 from any suitable storage device or devices (not shown) as indicated by an arrow 26. The storage devices may be portable or non-portable and may be directly connected to processing system 10, connected to processing system 10 through any number of intermediate devices (not shown), or may be remotely located from processing system 10 across one or more local, regional, or global communication networks such as the Internet (not shown).

Rendering engine 22 includes a rendering component 24 and inverse warping component 27. Rendering component 24 renders warped content 20 into rendered warped content, and inverse warping component 27 inversely warps the rendered warped content to allow rendering engine 22 to form unwarped reproduction 30 of stored content 12 as indicated by an arrow 28. Inverse warping component 27 performs the inverse warping subsequent to or contemporaneous with rendering component 24 rendering warped content 20.

Where warped content 20 includes visual information, rendering component 24 renders warped content 20 into rendered warped content that is suitable for display, and inverse warping component 27 inversely warps the rendered warped content so that rendering engine 22 displays unwarped reproduction 30 onto a display surface (not shown in FIG. 1B). Similarly, where warped content 20 includes audio information, rendering component 24 renders warped content 20 into rendered warped content by creating an audio signal corresponding to warped content 20, and inverse warping component 27 inversely warps the audio signal so that rendering engine 22 plays unwarped reproduction 30 with a suitable listening device.

As noted above, rendering engine 22 does not receive or otherwise access stored content 12. In addition, rendering engine 22 does not recreate or attempt to recreate stored content 12 as part of the process of producing unwarped reproduction 30 from warped content 20. Accordingly, unwarped stored content 12 is not able to be accessed or copied from rendering engine 22.

The generation and use of warped content 20 results in form of analog cryptographic protection where the actual content of stored content 12 is encrypted in warped content 20 and is decrypted using inverse warping component 27 to produce unwarped reproduction 30. Accordingly, even if other forms of security such as digital rights management that are applied to warped content are compromised, warped content 20 may not be reproduced without distortion without using inverse warping component 27.

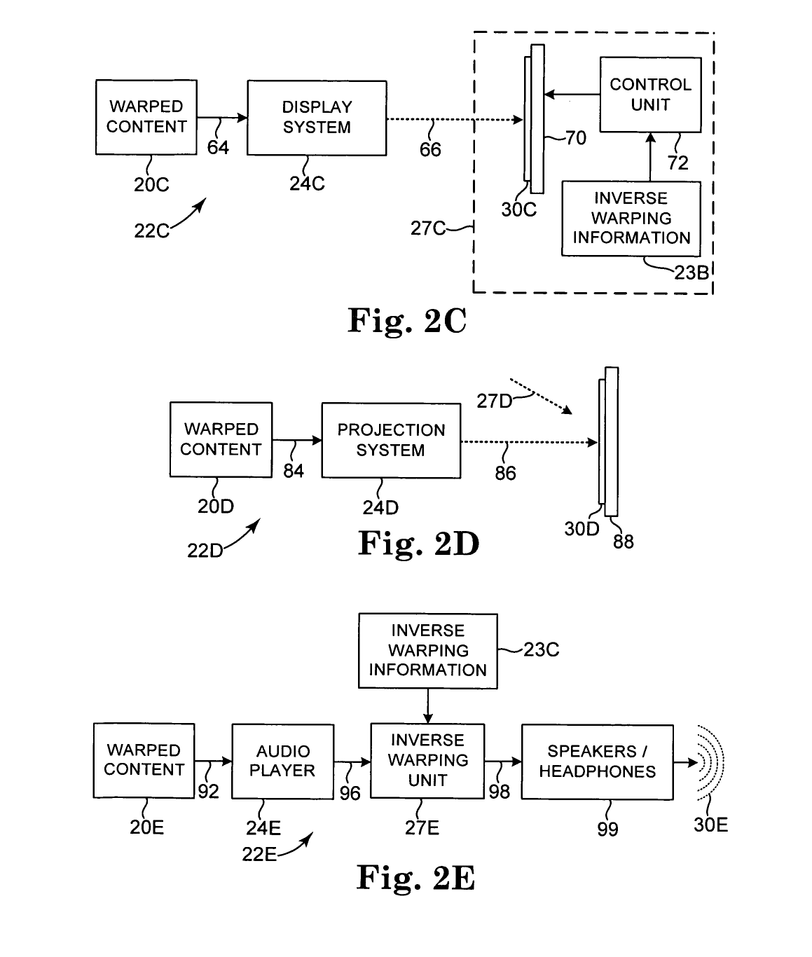

FIGS. 2A-2E are diagrams illustrating various embodiments 22A-22E, respectively, of rendering engine 22 that are each configured to produce unwarped reproductions 30A-30E, respectively, from warped content 20A-20E, respectively. In the embodiments of FIGS. 2A-2D, rendering engines 22A-22D produce visual unwarped reproductions 30A-30D, respectively. In the embodiment of FIG. 2E, rendering engine 22E produces audio unwarped reproduction 30E, respectively.

With the embodiment of rendering engine 22A shown in FIG. 2A, rendering component 24A includes a display system and inverse warping component 27A includes a spatially non-uniform display surface 42. Warped content 20A includes a defined distortion pattern from spatial distortions formed in warped content 20A. The display system receives warped content 20A as indicated by an arrow 34, renders warped content 20A, and displays the rendered warped content onto non-uniform display surface 42 as indicated by a dashed arrow 36. Various points or regions of non-uniform display surface 42 have varying distances from the display system. The varying distances correspond to the warping parameters used to generate warped content 20A. As a result of the non-uniformities, display surface 42 inversely warps the rendered warped content in its field of view to produce unwarped reproduction 30A. Display surface 42 inversely warps the rendered warped content subsequent to warped content 20A being rendered by the display system.

In one embodiment, inverse warping component 27A also includes a control unit 46 and receives inverse warping information 23A. Control unit 46 configures non-uniform display surface 42 as specified by inverse warping information 23A in this embodiment. To do so, control unit 46 causes any number of retractable sticks 44 to be adjusted. Each retractable stick 44 connects to a point or region of display surface 42 and causes the point or region to be moved relative to the display system. By independently adjusting each retractable stick 44, control unit 46 causes display surface 42 to form an overall shape that inversely warps the rendered warped content from the display system to display unwarped reproduction 30A. Control unit 46 may dynamically reconfigure non-uniform display surface 42 at any time by adjusting retractable sticks 44 according to different inverse warping information 23A. Retractable sticks 44 may be replaced with any other suitable mechanical devices for adjusting display surface 42 in other embodiments.

In another embodiment, non-uniform display surface 42 is statically configured. In this embodiment, inverse warping component 27A does not include control unit 46 and does not receive inverse warping information 23A. Inverse warping information 23A is inherently contained in inverse warping component 27A in this embodiment. Inverse warping information 23A that specifies the static configuration of non-uniform display surface 42 may be provided to processing system 10 (shown in FIG. 1A) as described above for use in generating warping information 16 that is used to generate warped content 20A.

With the embodiment of rendering engine 22B shown in FIG. 2B, rendering component 24B includes a projection system and inverse warping component 27B includes an inverse warping lens within or adjacent to the projection system. Warped content 20B includes a defined distortion pattern from spatial distortions formed in warped content 20B. The projection system receives warped content 20B as indicated by an arrow 54 and renders warped content 20B. The projection system projects the rendered warped content through the inverse warping lens to inversely warp the rendered warped content onto a display surface 58 as indicated by a dashed arrow 56. The inverse warping lens is configured to include a defined distortion pattern that corresponds to the warping parameters in warping information 16 that are used to generate the defined distortion pattern of warped content 20B. The defined distortion pattern of the inverse warping lens serves to inversely warp the rendered warped content to produce unwarped reproduction 30B on display surface 58. The inverse warping lens inversely warps the rendered warped content subsequent to or contemporaneous with warped content 20B being projected by the projection system.

Inverse warping information (not shown) that specifies the configuration of the inverse warping lens may be provided to processing system 10 (shown in FIG. 1A) as described above for use in generating warping information 16 that is used to generate warped content 20B.

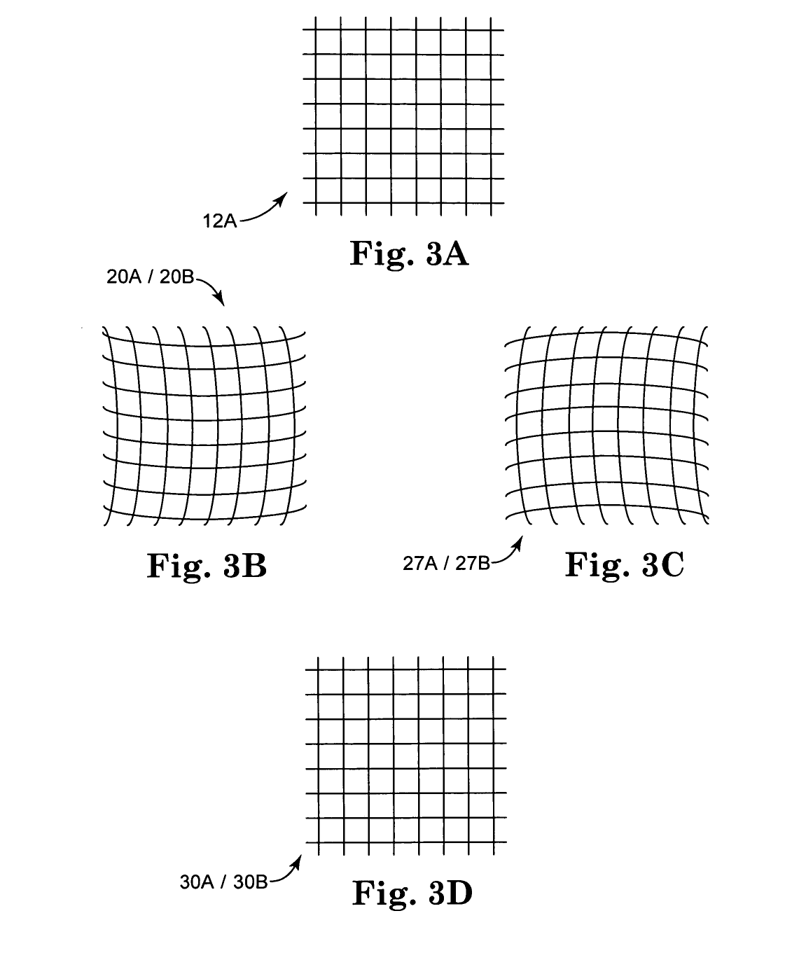

In the embodiments of FIGS. 2A and 2B, unwarped reproductions 30A and 30B are formed by spatially warping and spatially inverse warping stored content 12. FIGS. 3A-3D are diagrams illustrating an example of spatially warping and inverse warping visual content.

FIG. 3A illustrates a reproduction of stored content 12A as it is intended to be viewed when rendered by rendering engine. FIG. 3B illustrates a reproduction of warped content 20A and 20B when rendered by rendering engine without inverse warping being applied. As shown, the reproduction of warped content 20A or 20B appears with a defined distortion pattern when compared to the reproduction of stored content 12A. FIG. 3C illustrates the inverse warping configuration of inverse warping components 27A and 27B. By inversely warping warped content 20A and 20B, rendering engines 22A and 22B produce unwarped reproductions 30A and 30B, respectively, as shown in FIG. 3D. Unwarped reproductions 30A and 30B reproduce stored content 12A as shown in FIG. 3A and do not include the defined distortion pattern shown in FIG. 3B.

With the embodiment of rendering engine 22C shown in FIG. 2C, rendering component 24C includes a display system and inverse warping component 27C includes a display surface 70 with color, reflective, or refractive non-uniformities. Warped content 20C includes a defined distortion pattern from color or light amplitude distortions. Color or light amplitude distortions may be formed using non-uniform gain factors for different regions in warped content 20C. The display system receives warped content 20C as indicated by an arrow 64, renders warped content 20C, and displays the rendered warped content onto non-uniform display surface 70 as indicated by a dashed arrow 66. Various points or regions of non-uniform display surface 70 have varying color, reflective, or refractive properties. The varying color, reflective, or refractive properties compensate for the warping parameters used to generate warped content 20C. As a result of the compensation by the non-uniformities, display surface 70 inversely warps the rendered warped content to produce unwarped reproduction 30C. Display surface 70 inversely warps the rendered warped content subsequent to or contemporaneous with warped content 20C being rendered by the display system.

In one embodiment, inverse warping component 27C also includes a control unit 72 and receives inverse warping information 23B. Control unit 72 configures the color, reflective, or refractive properties of various points or regions of display surface 70 as specified by inverse warping information 23B in this embodiment. Control unit 72 may dynamically reconfigure display surface 70 at any time by adjusting the reflective or refractive properties of display surface 70 according to different inverse warping information 23B.

In another embodiment, the reflective or refractive properties display surface 70 are statically configured. In this embodiment, inverse warping component 27C does not include control unit 72 and does not receive inverse warping information 23B. Inverse warping information 23B is inherently contained in inverse warping component 27C in this embodiment. Inverse warping information 23B that specifies the static configuration of display surface 70 may be provided to processing system 10 (shown in FIG. 1A) as described above for use in generating warping information 16 that is used to generate warped content 20C.

With the embodiment of rendering engine 22D shown in FIG. 2D, rendering component 24D includes a projection system and inverse warping component 27D includes an inverse warping lighting (e.g., ambient lighting) as represented by a dashed arrow. Warped content 20D includes a defined distortion pattern from light amplitude distortions formed using gain factors that compensate for the inverse warping lighting. The projection system receives warped content 20D as indicated by an arrow 84 and renders warped content 20D. The projection system projects the rendered warped content onto a display surface 88 as indicated by a dashed arrow 86. Ambient or other light from inverse warping lighting impinges on display surface 88 and interferes with the light from the projected content to inversely warp the projected content on display surface 88 to produce unwarped reproduction 30D. The inverse warping light forms a defined distortion pattern on display surface 88 that corresponds to the warping parameters in warping information 16 that are used to generate the defined distortion pattern of warped content 20D. The defined distortion pattern of the inverse warping light serves to inversely warp the rendered warped content to produce unwarped reproduction 30D on display surface 88. The inverse warping light inversely warps the rendered warped content subsequent to or contemporaneous with warped content 20D being projected by the projection system.

Inverse warping information (not shown) that specifies the configuration of the inverse warping light may be provided to processing system 10 (shown in FIG. 1A) as described above for use in generating warping information 16 that is used to generate warped content 20D.

With the embodiment of rendering engine 22E shown in FIG. 2E, rendering component 24E includes an audio player and inverse warping component 27E includes an inverse warping unit. Warped content 20E includes a defined distortion pattern from periodic time or sound amplitude distortions. The audio player receives warped content 20E as indicated by a dashed arrow 92, renders warped content 20D to form an audio signal, and provides the audio signal to the inverse warping unit as indicated by an arrow 96. The inverse warping unit inversely warps the audio signal by removing the periodic time or sound amplitude distortions provides the inversely warped audio signal to a speakers or headphones 99 to produce unwarped reproduction 30E. The inverse warping unit inversely warps the rendered warped content subsequent to or contemporaneous with warped content 20E audio player 24E generating the audio signal.

In one embodiment, the inverse warping unit receives inverse warping information 23C. The inverse warping unit inversely warps the audio signal as specified by inverse warping information 23C in this embodiment.

In another embodiment, the inverse warping unit may be statically formed as part of speakers or headphones 99. Inverse warping information 23C is inherently contained in the inverse warping unit in this embodiment. Inverse warping information 23C that specifies the static configuration of the inverse warping unit may be provided to processing system 10 (shown in FIG. 1A) as described above for use in generating warping information 16 that is used to generate warped content 20E.

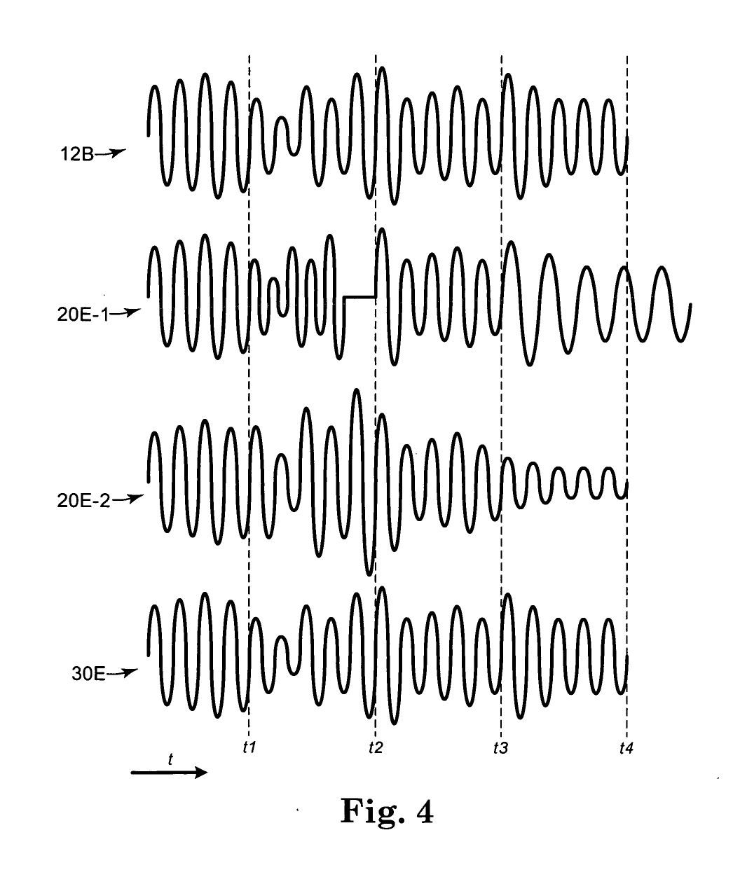

In the embodiment of FIG. 2E, unwarped reproduction 30E is formed by temporal or sound amplitude warping and temporal or sound amplitude inverse warping stored content 12. FIG. 4 is a diagram illustrating examples of temporal and sound amplitude warping and temporal and sound amplitude inverse warping audio stored content 12B. FIG. 4 shows a reproduction of stored content 12B as it is intended to be heard when rendered by rendering engine.

A reproduction of warped content 20E-1 illustrates temporal warping of stored content 12B. Warped content 20E-1 includes defined temporal distortion patterns between times t1 and t2 and between times t3 and t4 when compared to stored content 12B. The temporal distortion between times t1 and t2 is formed by compressing stored content 12B, and the temporal distortion between times t3 and t4 is formed by expanding stored content 12B. To produce unwarped reproduction 30E from warped content 20E-1 as shown in FIG. 4, the inverse warping unit expands warped content 20E-1 between times t1 and t2 and compresses warped content 20E-1 between t3 and t4.

A reproduction of warped content 20E-2 illustrates sound amplitude warping of stored content 12B. Warped content 20E-2 includes defined sound amplitude distortion patterns between times t1 and t2 and between times t3 and t4 when compared to stored content 12B. The sound amplitude distortion between times t1 and t2 is formed by enhancing the amplitudes of stored content 12B, and the sound amplitude distortion between times t3 and t4 is formed by reducing the amplitudes of stored content 12B. To produce unwarped reproduction 30E from warped content 20E-2 as shown in FIG. 4, the inverse warping unit reduces the amplitudes of warped content 20E-2 between times t1 and t2 and enhances the amplitudes of warped content 20E-2 between t3 and t4.

Unwarped reproduction 30E reproduces stored content 12B as shown in FIG. 4 and does not include the defined distortion patterns of warped content 20E-1 or warped content 20E-2.

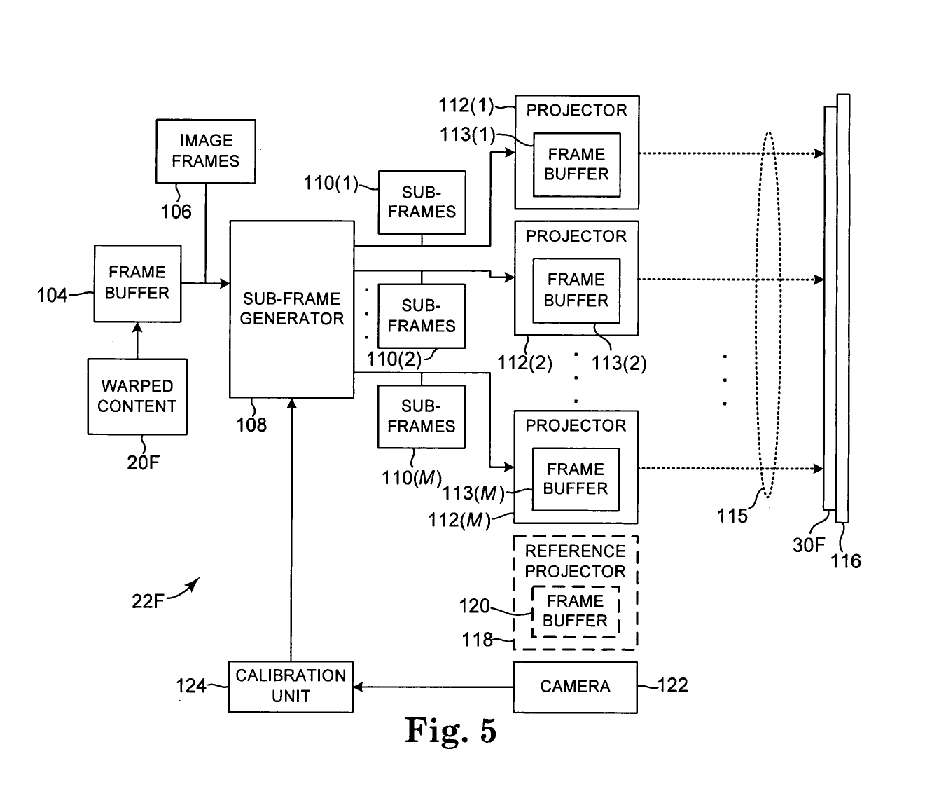

FIG. 5 is a block diagram illustrating one embodiment of a rendering engine 22F that is configured to produce an unwarped reproduction 30F of stored content 12 from warped content 20F. In the embodiment of FIG. 5, rendering engine 22F forms a projection system with multiple projectors 112 that are configured to display sub-frames 110 onto a display surface 116. A sub-frame generator 108 generates sub-frames 110 from warped content 20F. Warped content 20F is generated remotely from sub-frame generator 108 and rendering engine 22F. Sub-frame generator 108 and projectors 112 form a rendering component (not shown in FIG. 5) of rendering engine 22F. Rendering engine 22F renders warped content 20F to generate sub-frames 110, projects sub-frames 110 using projectors 112, and inversely warps sub-frames 110 to display corresponding unwarped reproduction 30F of stored content 12.

Depending on the embodiment, one or more components of rendering engine 22F form an inverse warping component of rendering engine 22F.

In one embodiment of rendering engine 22F, display surface 116 includes inverse warping component 27A (shown in FIG. 2A) to form the inverse warping component of rendering engine 22F. In this embodiment, projectors 112 project sub-frames 110 such that the combined projection 115 of sub-frames 110 would appear warped prior to being inversely warped. Display surface 116 inversely warps the projection 115 of sub-frames 110 to display unwarped reproduction 30F as described above with reference to FIG. 2A.

In another embodiment of rendering engine 22F, each projector 112 includes an inverse warping lens 27B (shown in FIG. 2B, not shown in FIG. 5) where the lenses combine to form the inverse warping component of rendering engine 22F. In this embodiment, the combined projection 115 of sub-frames 110 is inversely warped by inverse warping lens 27B as described above with reference to FIG. 2B and displays unwarped reproduction 30F on display surface 116.

In a further embodiment of rendering engine 22F, display surface 116 includes inverse warping component 27C (shown in FIG. 2C) to form the inverse warping component of rendering engine 22F. In this embodiment, projectors 112 project sub-frames 110 such that the combined projection 115 of sub-frames 110 would appear warped prior to being inversely warped. Display surface 116 inversely warps the projection 115 of sub-frames 110 to display unwarped reproduction 30F as described above with reference to FIG. 2C.

In yet another embodiment of rendering engine 22F, rendering engine 22F includes inverse warping component 27D (shown in FIG. 2D, not shown in FIG. 5) to form the inverse warping component of rendering engine 22F. In this embodiment, the combined projection 115 of sub-frames 110 is inversely warped by inverse warping component 27D as described above with reference to FIG. 2D and appears as unwarped reproduction 30F on display surface 116.

Referring to FIG. 5, rendering engine 22F includes image frame buffer 104, sub-frame generator 108, projectors 112(1)-112(N) where N is greater than or equal to two (collectively referred to as projectors 112), camera 122, and calibration unit 124. Image frame buffer 104 receives and buffers warped content 20F to create image frames 106. Sub-frame generator 108 processes image frames 106 to define corresponding image sub-frames 110(1)-10(N) (collectively referred to as sub-frames 110). For each image frame 106, sub-frame generator 108 generates one sub-frame 110 for each projector 112. Sub-frames 110-100(N) are received by projectors 112-112(N), respectively, and stored in image frame buffers 113-113(N) (collectively referred to as image frame buffers 113), respectively. Projectors 112(1)-112(N) project the sub-frames 110(1)-110(N), respectively, onto display surface 116 to produce unwarped reproduction 30F for viewing by a user.

Image frame buffer 104 includes memory for storing warped content 20F for one or more image frames 106. Thus, image frame buffer 104 constitutes a database of one or more image frames 106. Image frame buffers 113 also include memory for storing sub-frames 110. Examples of image frame buffers 104 and 113 include non-volatile memory (e.g., a hard disk drive or other persistent storage device) and may include volatile memory (e.g., random access memory (RAM)).

Sub-frame generator 108 receives and processes image frames 106 to define a plurality of image sub-frames 110. Sub-frame generator 108 generates sub-frames 110 based on image data in image frames 106. In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106. Sub-frame generator 108 may generates sub-frames 110 to fully or partially overlap in any suitable tiled and/or superimposed arrangement on display surface 116.

Projectors 112 receive image sub-frames 110 from sub-frame generator 108 and, in one embodiment, simultaneously project the image sub-frames 110 onto display surface 116 at overlapping and spatially offset positions to produce unwarped reproduction 30F. In one embodiment, rendering engine 22F is configured to give the appearance to the human eye of high-resolution unwarped reproductions 30F by displaying overlapping and spatially shifted lower-resolution sub-frames 110 from multiple projectors 112. In one embodiment, the projection of overlapping and spatially shifted sub-frames 110 gives the appearance of enhanced resolution (i.e., higher resolution than the sub-frames 110 themselves).

Sub-frame generator 108 determines appropriate values for the sub-frames 110 so that the combined image produced from sub-frames 110 prior to being inversely warped is close in appearance to how the high-resolution image (e.g., image frame 106) from which the sub-frames 110 were derived would appear if displayed directly.

It will be understood by a person of ordinary skill in the art that functions performed by sub-frame generator 108 may be implemented in hardware, software, firmware, or any combination thereof. The implementation may be via a microprocessor, programmable logic device, or state machine. Components of the embodiments described herein may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

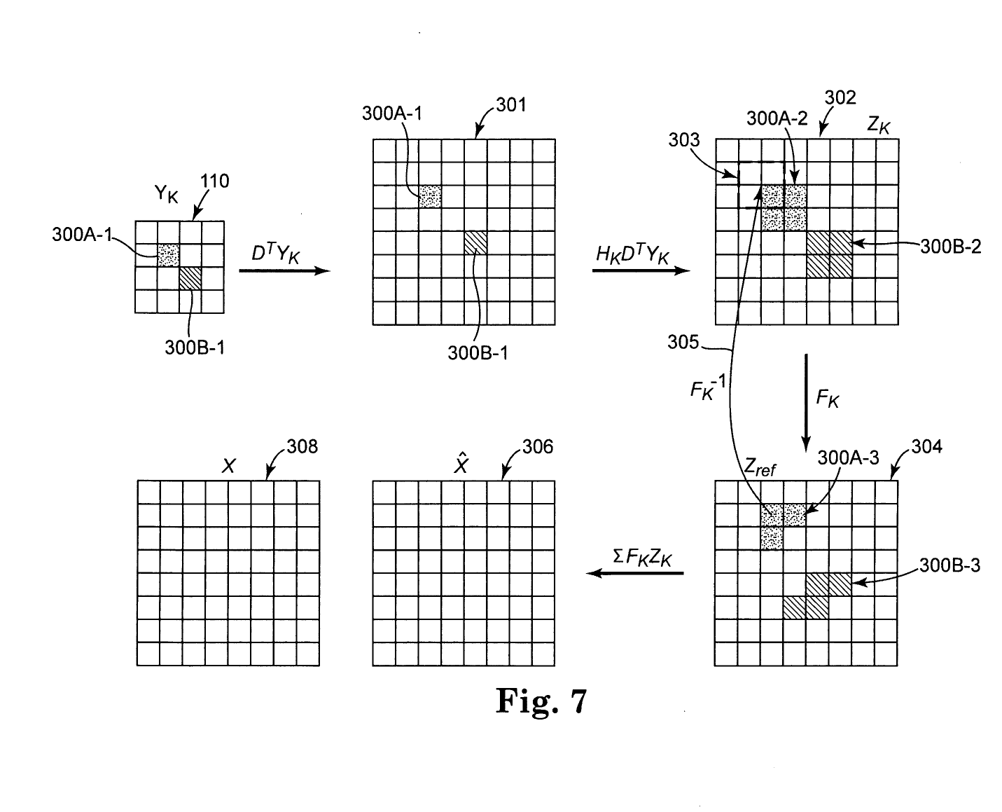

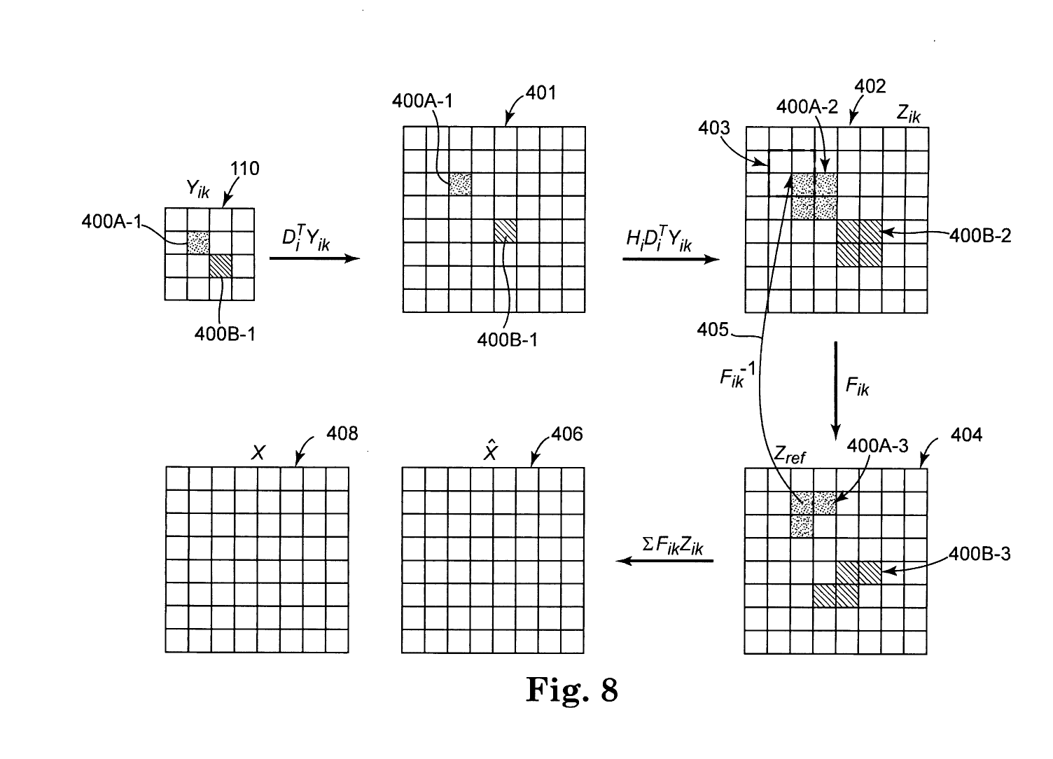

Also shown in FIG. 5 is reference projector 118 with an image frame buffer 120. Reference projector 118 is shown with dashed lines in FIG. 5 because, in one embodiment, projector 118 is not an actual projector, but rather is a hypothetical high-resolution reference projector that is used in an image formation model for generating optimal sub-frames 110, as described in further detail below with reference to the embodiments of FIGS. 7 and 8. In one embodiment, the location of one of the actual projectors 112 is defined to be the location of the reference projector 118.

In one embodiment, rendering engine 22F includes the at least one camera 122 and a calibration unit 124, which are used in one embodiment to automatically determine a geometric mapping between each projector 112 and the reference projector 118, as described in further detail below with reference to FIGS. 7 and 8.

In one embodiment, rendering engine 22F includes hardware, software, firmware, or a combination of these. In one embodiment, one or more components of rendering engine 22F are included in a computer, computer server, or other microprocessor-based system capable of performing a sequence of logic operations. In addition, processing can be distributed throughout the system with individual portions being implemented in separate system components, such as in a networked or multiple computing unit environment.

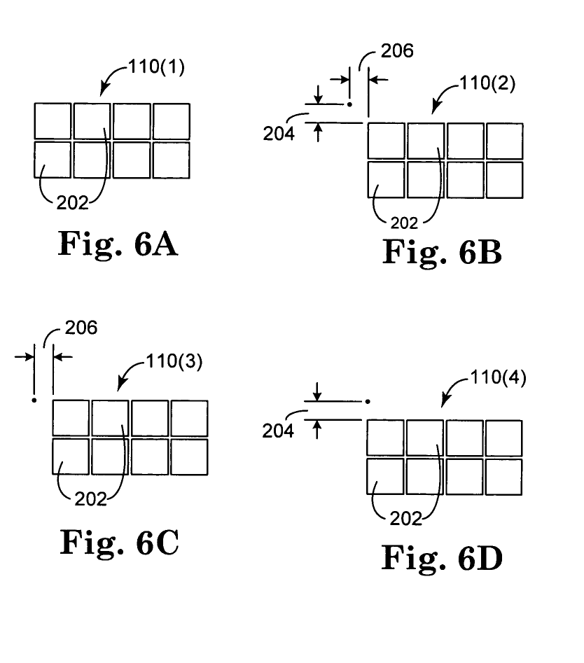

FIGS. 6A-6D are schematic diagrams illustrating the projection of four sub-frames 110(1), 110(2), 110(3), and 110(4). In this embodiment, rendering engine 22F includes four projectors 112, and sub-frame generator 108 generates at least a set of four sub-frames 110(1), 110(2), 110(3), and 110(4) for each image frame 106 for display by projectors 112. As such, sub-frames 110(1), 110(2), 110(3), and 110(4) each include a plurality of columns and a plurality of rows of individual pixels 202 of image data.

FIG. 6A illustrates the display of sub-frame 110(1) by a first projector 112(1). As illustrated in FIG. 6B, a second projector 112(2) displays sub-frame 110(2) offset from sub-frame 110(1) by a vertical distance 204 and a horizontal distance 206. As illustrated in FIG. 6C, a third projector 112(3) displays sub-frame 110(3) offset from sub-frame 110(1) by horizontal distance 206. A fourth projector 112(4) displays sub-frame 110(4) offset from sub-frame 110(1) by vertical distance 204 as illustrated in FIG. 6D.

Sub-frame 110(1) is spatially offset from sub-frame 110(2) by a predetermined distance. Similarly, sub-frame 110(3) is spatially offset from sub-frame 110(4) by a predetermined distance. In one illustrative embodiment, vertical distance 204 and horizontal distance 206 are each approximately one-half of one pixel.

The display of sub-frames 110(2), 110(3), and 110(4) are spatially shifted relative to the display of sub-frame 110(1) by vertical distance 204, horizontal distance 206, or a combination of vertical distance 204 and horizontal distance 206. As such, pixels 202 of sub-frames 110(1), 110(2), 110(3), and 110(4) at least partially overlap thereby producing the appearance of higher resolution pixels. Sub-frames 110(1), 110(2), 110(3), and 110(4) may be superimposed on one another (i.e., fully or substantially fully overlap), may be tiled (i.e., partially overlap at or near the edges), or may be a combination of superimposed and tiled. The overlapped sub-frames 110(1), 110(2), 110(3), and 110(4) also produce a brighter overall image than any of sub-frames 110(1), 110(2), 110(3), or 110(4) alone.

In other embodiments, other numbers of projectors 112 are used in rendering engine 22F and other numbers of sub-frames 110 are generated for each image frame 106.

In other embodiments, sub-frames 110(1), 110(2), 110(3), and 110(4) may be displayed at other spatial offsets relative to one another and the spatial offsets may vary over time.

In one embodiment, sub-frames 110 have a lower resolution than image frames 106. Thus, sub-frames 110 are also referred to herein as low-resolution images or sub-frames 110, and image frames 106 are also referred to herein as high-resolution images or frames 106. The terms low resolution and high resolution are used herein in a comparative fashion, and are not limited to any particular minimum or maximum number of pixels.

In one embodiment, rendering engine 22F produces a superimposed projected output that takes advantage of natural pixel mis-registration to provide a unwarped reproduction 30F with a higher resolution than the individual sub-frames 110. In one embodiment, image formation due to multiple overlapped projectors 112 is modeled using a signal processing model. Optimal sub-frames 110 for each of the component projectors 112 are estimated by sub-frame generator 108 based on the model, such that the resulting image predicted by the signal processing model is as close as possible to the desired high-resolution image to be projected. In one embodiment described in additional detail with reference to FIG. 8 below, the signal processing model is used to derive values for the sub-frames 110 that minimize visual color artifacts that can occur due to offset projection of single-color sub-frames 110.

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image. The generation of optimal sub-frames 110 based on a simulated high-resolution image and a desired high-resolution image is described in further detail below with reference to the embodiments of FIGS. 7 and 8.

One form of the embodiment of FIG. 8 determines and generates single-color sub-frames 110 for each projector 112 that minimize color aliasing due to offset projection. This process may be thought of as inverse de-mosaicking. A de-mosaicking process seeks to synthesize a high-resolution, full color image free of color aliasing given color samples taken at relative offsets. One form of the embodiment of FIG. 8 essentially performs the inverse of this process and determines the colorant values to be projected at relative offsets, given a full color high-resolution image 106.

FIG. 7 is a diagram illustrating a model of an image formation process according to one embodiment. The sub-frames 110 are represented in the model by Yₖ, where “k” is an index for identifying the individual projectors 112. Thus, Y₁, for example, corresponds to a sub-frame 110(1) for a first projector 112(1), Y₂ corresponds to a sub-frame 110(2) for a second projector 112(2), etc. Two of the sixteen pixels of the sub-frame 110 shown in FIG. 7 are highlighted, and identified by reference numbers 300A-1 and 300B-1. The sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Zₖ) with “chunky pixels”. This relationship is expressed in the following Equation I:

Zₖ=HₖD^{T}Yₖ Equation I
where:
   k=index for identifying the projectors 112;
   Zₖ=low-resolution sub-frame 110 of the kth projector 112 on a hypothetical high-resolution grid;
   Hₖ=Interpolating filter for low-resolution sub-frame 110 from kth projector 112;
   D^{T}=up-sampling matrix; and
   Yₖ=low-resolution sub-frame 110 of the kth projector 112.

The low-resolution sub-frame pixel data (Yₖ) is expanded with the up-sampling matrix (D^{T}) so that the sub-frames 110 (Yₖ) can be represented on a high-resolution grid. The interpolating filter (Hₖ) fills in the missing pixel data produced by up-sampling. In the embodiment shown in FIG. 7, pixel 300A-1 from the original sub-frame 110 (Yₖ) corresponds to four pixels 300A-2 in the high-resolution image 302 (Zₖ), and pixel 300B-1 from the original sub-frame 110 (Yₖ) corresponds to four pixels 300B-2 in the high-resolution image 302 (Zₖ). The resulting image 302 (Zₖ) in Equation I models the output of the k^{th} projector 112 if there was no relative distortion or noise in the projection process. Relative geometric distortion between the projected component sub-frames 110 results due to the different optical paths and locations of the component projectors 112. A geometric transformation is modeled with the operator, Fₖ, which maps coordinates in the frame buffer 113 of the k^{th} projector 112 to the frame buffer 120 of the reference projector 118 (FIG. 5) with sub-pixel accuracy, to generate a warped image 304 (Z_{ref}). In one embodiment, Fₖ is linear with respect to pixel intensities, but is non-linear with respect to the coordinate transformations. As shown in FIG. 7, the four pixels 300A-2 in image 302 are mapped to the three pixels 300A-3 in image 304, and the four pixels 300B-2 in image 302 are mapped to the four pixels 300B-3 in image 304.

In one embodiment, the geometric mapping (Fₖ) is a floating-point mapping, but the destinations in the mapping are on an integer grid in image 304. Thus, it is possible for multiple pixels in image 302 to be mapped to the same pixel location in image 304, resulting in missing pixels in image 304. To avoid this situation, in one embodiment, during the forward mapping (Fₖ), the inverse mapping (Fₖ⁻¹) is also utilized as indicated at 305 in FIG. 7. Each destination pixel in image 304 is back projected (i.e., Fₖ⁻¹) to find the corresponding location in image 302. For the embodiment shown in FIG. 7, the location in image 302 corresponding to the upper-left pixel of the pixels 300A-3 in image 304 is the location at the upper-left corner of the group of pixels 300A-2. In one embodiment, the values for the pixels neighboring the identified location in image 302 are combined (e.g., averaged) to form the value for the corresponding pixel in image 304. Thus, for the example shown in FIG. 7, the value for the upper-left pixel in the group of pixels 300A-3 in image 304 is determined by averaging the values for the four pixels within the frame 303 in image 302.

In another embodiment, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 is mapped to a floating point location in image 304, some of the image data for the pixel is essentially scattered to multiple pixels neighboring the floating point location in image 304. Thus, each pixel in image 304 may receive contributions from multiple pixels in image 302, and each pixel in image 304 is normalized based on the number of contributions it receives.

A superposition/summation of such warped images 304 from all of the component projectors 112 forms a hypothetical or simulated high-resolution image 306 (X-hat) in the reference projector frame buffer 120, as represented in the following Equation II:

$$\hat{X} = {\sum }_{k}^{ } {F}_{k} {Z}_{k} \qquad Equation II$$

where:
   k=index for identifying the projectors 112;
   X-hat=hypothetical or simulated high-resolution image 306 in the reference projector frame buffer 120;
   Fₖ=operator that maps a low-resolution sub-frame 110 of the kth projector 112 on a hypothetical high-resolution grid to the reference projector frame buffer 120; and
   Zₖ=low-resolution sub-frame 110 of kth projector 112 on a hypothetical high-resolution grid, as defined in Equation I.

If the simulated high-resolution image 306 (X-hat) in the reference projector frame buffer 120 is identical to a given (desired) high-resolution image 308 (X), the system of component low-resolution projectors 112 would be equivalent to a hypothetical high-resolution projector placed at the same location as the reference projector 118 and sharing its optical path. In one embodiment, the desired high-resolution images 308 are the high-resolution image frames 106 (FIG. 5) received by sub-frame generator 108.

In one embodiment, the deviation of the simulated high-resolution image 306 (X-hat) from the desired high-resolution image 308 (X) is modeled as shown in the following Equation III:

X=\hat{X}+η Equation III
where:
   X=desired high-resolution frame 308;
   X-hat=hypothetical or simulated high-resolution frame 306 in the reference projector frame buffer 120; and
   η=error or noise term.

As shown in Equation III, the desired high-resolution image 308 (x) is defined as the simulated high-resolution image 306 (X-hat) plus η, which in one embodiment represents zero mean white Gaussian noise.

The solution for the optimal sub-frame data (Yₖ*) for the sub-frames 110 is formulated as the optimization given in the following Equation IV:

$${Y}_{k}^{*} = {arg max}_{{Y}_{k}} P ( \hat{X} \vert X ) \qquad Equation IV$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in the reference projector frame buffer 120, as defined in Equation II;
   X=desired high-resolution frame 308; and
   P(X-hat|X)=probability of X-hat given X.

Thus, as indicated by Equation IV, the goal of the optimization is to determine the sub-frame values (Yₖ) that maximize the probability of X-hat given X. Given a desired high-resolution image 308 (X) to be projected, sub-frame generator 108 (FIG. 5) determines the component sub-frames 110 that maximize the probability that the simulated high-resolution image 306 (X-hat) is the same as or matches the “true” high-resolution image 308 (X).

Using Bayes rule, the probability P(X-hat|X) in Equation IV can be written as shown in the following Equation V:

$$P ( \hat{X} \vert X ) = \frac{P ( X \vert \hat{X} ) P ( \hat{X} )}{P ( X )} \qquad Equation V$$

where:
   X-hat=hypothetical or simulated high-resolution frame 306 in the reference projector frame buffer 120, as defined in Equation II;
   X=desired high-resolution frame 308;
   P(X-hat|X)=probability of X-hat given X;
   P(X|X-hat)=probability of X given X-hat;
   P(X-hat)=prior probability of X-hat; and
   P(X)=prior probability of X.

The term P(X) in Equation V is a known constant. If X-hat is given, then, referring to Equation III, X depends only on the noise term, η, which is Gaussian. Thus, the term P(X|X-hat) in Equation V will have a Gaussian form as shown in the following Equation VI:

$$P ( X \vert \hat{X} ) = \frac{1}{C} {e}^{- \frac{{‖ X - \hat{X} ‖}^{2}}{2 {σ}^{2}}} \qquad Equation VI$$

where:
   X-hat=hypothetical or simulated high-resolution frame 306 in the reference projector frame buffer 120, as defined in Equation II;
   X=desired high-resolution frame 308;
   P(X|X-hat)=probability of X given X-hat;
   C=normalization constant; and
   σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VII:

$$P ( \hat{X} ) = \frac{1}{Z ( β )} {e}^{- \{ {β}^{2} ( {‖ ∇ \hat{X} ‖}^{2} ) \}} \qquad Equation VII$$

where:
   P(X-hat)=prior probability of X-hat;
   β=smoothing constant;
   Z(β)=normalization function;
   ∇=gradient operator; and
   X-hat=hypothetical or simulated high-resolution frame 306 in the reference projector frame buffer 120, as defined in Equation II.

In another embodiment, the smoothness requirement is based on a prior Laplacian model, and is expressed in terms of a probability distribution for X-hat given by the following Equation VIII:

$$P ( \hat{X} ) = \frac{1}{Z ( β )} {e}^{- \{ β ( ‖ ∇ \hat{X} ‖ ) \}} \qquad Equation VIII$$

where:
   P(X-hat)=prior probability of X-hat;
   β=smoothing constant;
   Z(β)=normalization function;
   ∇=gradient operator; and
   X-hat=hypothetical or simulated high-resolution frame 306 in the reference projector frame buffer 120, as defined in Equation II.

The following discussion assumes that the probability distribution given in Equation VII, rather than Equation VIII, is being used. As will be understood by persons of ordinary skill in the art, a similar procedure would be followed if Equation VIII were used. Inserting the probability distributions from Equations VI and VII into Equation V, and inserting the result into Equation IV, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation IV is transformed into a function minimization problem, as shown in the following Equation IX:

$${Y}_{k}^{*} = {arg min}_{{Y}_{k}} {‖ X - \hat{X} ‖}^{2} + {β}^{2} {‖ ∇ \hat{X} ‖}^{2} \qquad Equation IX$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in the reference projector frame buffer 120, as defined in Equation II;
   X=desired high-resolution frame 308;
   β=smoothing constant; and
   ∇=gradient operator.

The function minimization problem given in Equation IX is solved by substituting the definition of X-hat from Equation II into Equation IX and taking the derivative with respect to Yₖ, which results in an iterative algorithm given by the following Equation X:

Yₖ⁽ⁿ⁻¹⁾=Yₖ⁽ⁿ⁾−Θ{DHₖ^{T}Fₖ^{T}└(\hat{X}⁽ⁿ⁾−X)+β²∇²\hat{X}⁽ⁿ⁾┘} Equation X
where:
   k=index for identifying the projectors 112;
   n=index for identifying iterations;
   Yₖ⁽ⁿ⁺¹⁾=low-resolution sub-frame 110 for the kth projector 112 for iteration number n+1;
   Yₖ⁽ⁿ⁾=low-resolution sub-frame 110 for the kth projector 112 for iteration number n;
   Θ=momentum parameter indicating the fraction of error to be incorporated at each iteration;
   D=down-sampling matrix;
   Hₖ^{T}=Transpose of interpolating filter, Hₖ, from Equation I (in the image domain, Hₖ^{T} is a flipped version of Hₖ);
   Fₖ^{T}=Transpose of operator, Fₖ, from Equation II (in the image domain, Fₖ^{T} is the inverse of the warp denoted by Fₖ);
   X-hat⁽ⁿ⁾=hypothetical or simulated high-resolution frame 306 in the reference projector frame buffer 120, as defined in Equation II, for iteration number n;
   X=desired high-resolution frame 308;
   β=smoothing constant; and
   ∇²=Laplacian operator.

Equation X may be intuitively understood as an iterative process of computing an error in the reference projector 118 coordinate system and projecting it back onto the sub-frame data. In one embodiment, sub-frame generator 108 (FIG. 5) is configured to generate sub-frames 110 in real-time using Equation X. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation X can be implemented very efficiently with conventional image processing operations (e.g., transformations, down-sampling, and filtering). The iterative algorithm given by Equation X converges rapidly in a few iterations and is very efficient in terms of memory and computation (e.g., a single iteration uses two rows in memory; and multiple iterations may also be rolled into a single step). The iterative algorithm given by Equation X is suitable for real-time implementation, and may be used to generate optimal sub-frames 110 at video rates, for example.

To begin the iterative algorithm defined in Equation X, an initial guess, Yₖ⁽⁰⁾, for the sub-frames 110 is determined. In one embodiment, the initial guess for the sub-frames 110 is determined by texture mapping the desired high-resolution frame 308 onto the sub-frames 110. In one embodiment, the initial guess is determined from the following Equation XI:

Yₖ⁽⁰⁾DBₖFₖ^{T}X Equation XI
where:
   k=index for identifying the projectors 112;
   Yₖ⁽⁰⁾=initial guess at the sub-frame data for the sub-frame 110 for the kth projector 112;
   D=down-sampling matrix;
   Bₖ=interpolation filter;
   Fₖ^{T}=Transpose of operator, Fₖ, from Equation II (in the image domain, Fₖ^{T} is the inverse of the warp denoted by Fₖ); and
   X=desired high-resolution frame 308.

Thus, as indicated by Equation XI, the initial guess (Yₖ⁽⁰⁾) is determined by performing a geometric transformation (Fₖ^{T}) on the desired high-resolution frame 308 (X), and filtering (Bₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Bₖ).

In another embodiment, the initial guess, Yₖ⁽⁰⁾, for the sub-frames 110 is determined from the following Equation XII

Yₖ⁽⁰⁾=DFₖ^{T}X Equation XII
where:
   k=index for identifying the projectors 112;
   Yₖ⁽⁰⁾=initial guess at the sub-frame data for the sub-frame 110 for the kth projector 112;
   D=down-sampling matrix;
   Fₖ^{T}=Transpose of operator, Fₖ, from Equation II (in the image domain, Fₖ^{T} is the inverse of the warp denoted by Fₖ); and
   X=desired high-resolution frame 308.

Equation XII is the same as Equation XI, except that the interpolation filter (Bₖ) is not used.

Several techniques are available to determine the geometric mapping (Fₖ) between each projector 112 and the reference projector 118, including manually establishing the mappings, or using camera 122 and calibration unit 124 (FIG. 5) to automatically determine the mappings. In one embodiment, if camera 122 and calibration unit 124 are used, the geometric mappings between each projector 112 and the camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a rendering engine 22F with two projectors 112(1) and 112(2), assuming the first projector 112(1) is the reference projector 118, the geometric mapping of the second projector 112(2) to the first (reference) projector 112(1) can be determined as shown in the following Equation XIII:

F₂=T₂T₁⁻¹ Equation XIII
where:
   F₂=operator that maps a low-resolution sub-frame 110 of the second projector 112(2) to the first (reference) projector 112(1);
   T₁=geometric mapping between the first projector 112(1) and the camera 122; and
   T₂=geometric mapping between the second projector 112(2) and the camera 122.

In one embodiment, the geometric mappings (Fₖ) are determined once by calibration unit 124, and provided to sub-frame generator 108. In another embodiment, calibration unit 124 continually determines (e.g., once per frame 106) the geometric mappings (Fₖ), and continually provides updated values for the mappings to sub-frame generator 108.

One form of the multiple color projector embodiments provides a rendering engine 22F with multiple overlapped low-resolution projectors 112 coupled with an efficient real-time (e.g., video rates) image processing algorithm for generating sub-frames 110. Multiple low-resolution, low-cost projectors 112 may be used to produce high resolution images at high lumen levels but at lower cost than existing high-resolution projection systems, such as a single, high-resolution, high-output projector. One form of the embodiments provides a scalable rendering engine 22F that can provide virtually any desired resolution and brightness by adding any desired number of component projectors 112 to rendering engine 22F.

In some existing display systems, multiple low-resolution images are displayed with temporal and sub-pixel spatial offsets to enhance resolution. There are some important differences between these existing systems and the multiple color projector embodiments. For example, in one embodiment, there is no need for circuitry to offset the projected sub-frames 110 temporally. In one embodiment, the sub-frames 110 from the component projectors 112 are projected “in-sync”. As another example, unlike some existing systems where all of the sub-frames go through the same optics and the shifts between sub-frames are all simple translational shifts, in one embodiment, the sub-frames 110 are projected through the different optics of the multiple individual projectors 112. In one form of the multiple color projector embodiments, the signal processing model that is used to generate optimal sub-frames 110 takes into account relative geometric distortion among the component sub-frames 110, and is robust to minor calibration errors and noise.

It can be difficult to accurately align projectors into a desired configuration. In one form of the multiple color projector embodiments, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one form of the multiple color projector embodiments utilizes an optimal real-time sub-frame generation algorithm that explicitly accounts for arbitrary relative geometric distortion (not limited to homographies) between the component projectors 112, including distortions that occur due to a display surface 116 that is non-planar or has surface non-uniformities. One form of the multiple color projector embodiments generates sub-frames 110 based on a geometric relationship between a hypothetical high-resolution reference projector 118 at any arbitrary location and each of the actual low-resolution projectors 112, which may also be positioned at any arbitrary location.

In one embodiment, rendering engine 22F is configured to project images that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment described herein, a first plurality of the projectors 112 may be used to produce any desired brightness for the first image (e.g., left eye image), and a second plurality of the projectors 112 may be used to produce any desired brightness for the second image (e.g., right eye image). In another embodiment, rendering engine 22F may be combined or used with other display systems or display techniques, such as tiled displays.

Naïve overlapped projection of different colored sub-frames 110 by different projectors 112 can lead to significant color artifacts at the edges due to misregistration among the colors. In the embodiments of FIG. 8, sub-frame generator 108 determines the single-color sub-frames 110 to be projected by each projector 112 so that the visibility of color artifacts is minimized.

FIG. 8 is a diagram illustrating a model of an image formation process according to one embodiment. The sub-frames 110 are represented in the model by Yᵢₖ, where “k” is an index for identifying individual sub-frames 110, and “i” is an index for identifying color planes. Two of the sixteen pixels of the sub-frame 110 shown in FIG. 8 are highlighted, and identified by reference numbers 400A-1 and 400B-1. The sub-frames 110 (Yᵢₖ) are represented on a hypothetical high-resolution grid by up-sampling (represented by Dᵢ^{T}) to create up-sampled image 401. The up-sampled image 401 is filtered with an interpolating filter (represented by Hᵢ) to create a high-resolution image 402 (Zᵢₖ) with “chunky pixels”. This relationship is expressed in the following Equation XIV:

Zᵢₖ=HᵢDᵢ^{T}Yᵢₖ Equation XIV
where:
   k=index for identifying individual sub-frames 110;
   i=index for identifying color planes;
   Zᵢₖ=kth low-resolution sub-frame 110 in the ith color plane on a hypothetical high-resolution grid;
   Hᵢ=Interpolating filter for low-resolution sub-frames 110 in the ith color plane;
   Dᵢ^{T}=up-sampling matrix for sub-frames 110 in the ith color plane; and

Yᵢₖ=kth low-resolution sub-frame 110 in the ith color plane.

The low-resolution sub-frame pixel data (Yᵢₖ) is expanded with the up-sampling matrix (Dᵢ^{T}) so that the sub-frames 110 (Yᵢₖ) can be represented on a high-resolution grid. The interpolating filter (Hᵢ) fills in the missing pixel data produced by up-sampling. In the embodiment shown in FIG. 8, pixel 400A-1 from the original sub-frame 110 (Yᵢₖ) corresponds to four pixels 400A-2 in the high-resolution image 402 (Zᵢₖ), and pixel 400B-1 from the original sub-frame 110 (Yᵢₖ) corresponds to four pixels 400B-2 in the high-resolution image 402 (Zᵢₖ). The resulting image 402 (Zᵢₖ) in Equation XIV models the output of the projectors 112 if there was no relative distortion or noise in the projection process. Relative geometric distortion between the projected component sub-frames 110 results due to the different optical paths and locations of the component projectors 112. A geometric transformation is modeled with the operator, Fᵢₖ, which maps coordinates in the frame buffer 113 of a projector 112 to the frame buffer 120 of the reference projector 118 (FIG. 5) with sub-pixel accuracy, to generate a warped image 404 (Z_{ref}). In one embodiment, Fᵢₖ is linear with respect to pixel intensities, but is non-linear with respect to the coordinate transformations. As shown in FIG. 8, the four pixels 400A-2 in image 402 are mapped to the three pixels 400A-3 in image 404, and the four pixels 400B-2 in image 402 are mapped to the four pixels 400B-3 in image 404.

In one embodiment, the geometric mapping (Fᵢₖ) is a floating-point mapping, but the destinations in the mapping are on an integer grid in image 404. Thus, it is possible for multiple pixels in image 402 to be mapped to the same pixel location in image 404, resulting in missing pixels in image 404. To avoid this situation, in one embodiment, during the forward mapping (Fᵢₖ), the inverse mapping (Fᵢₖ⁻¹) is also utilized as indicated at 405 in FIG. 8. Each destination pixel in image 404 is back projected (i.e., Fᵢₖ⁻¹) to find the corresponding location in image 402. For the embodiment shown in FIG. 8, the location in image 402 corresponding to the upper-left pixel of the pixels 400A-3 in image 404 is the location at the upper-left corner of the group of pixels 400A-2. In one embodiment, the values for the pixels neighboring the identified location in image 402 are combined (e.g., averaged) to form the value for the corresponding pixel in image 404. Thus, for the example shown in FIG. 8, the value for the upper-left pixel in the group of pixels 400A-3 in image 404 is determined by averaging the values for the four pixels within the frame 403 in image 402.

In another embodiment, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 402 is mapped to a floating point location in image 404, some of the image data for the pixel is essentially scattered to multiple pixels neighboring the floating point location in image 404. Thus, each pixel in image 404 may receive contributions from multiple pixels in image 402, and each pixel in image 404 is normalized based on the number of contributions it receives.

A superposition/summation of such warped images 404 from all of the component projectors 112 in a given color plane forms a hypothetical or simulated high-resolution image (X-hatᵢ) for that color plane in the reference projector frame buffer 120, as represented in the following Equation XV:

$${\hat{X}}_{i} = {\sum }_{k}^{ } {F}_{ik} {Z}_{ik} \qquad Equation XV$$

where:
   k=index for identifying individual sub-frames 110;
   i=index for identifying color planes;
   X-hatᵢ=hypothetical or simulated high-resolution image for the ith color plane in the reference projector frame buffer 120;
   Fᵢₖ=operator that maps the kth low-resolution sub-frame 110 in the ith color plane on a hypothetical high-resolution grid to the reference projector frame buffer 120; and
   Zᵢₖ=kth low-resolution sub-frame 110 in the ith color plane on a hypothetical high-resolution grid, as defined in Equation XIV.

A hypothetical or simulated image 406 (X-hat) is represented by the following Equation XVI:

\hat{X}=[\hat{X}₁ \hat{X}₂ . . . \hat{X}_{N}]^{T} Equation XVI
where:
   X-hat=hypothetical or simulated high-resolution image in the reference projector frame buffer 120;
   X-hat₁=hypothetical or simulated high-resolution image for the first color plane in the reference projector frame buffer 120, as defined in Equation XV;
   X-hat₂=hypothetical or simulated high-resolution image for the second color plane in the reference projector frame buffer 120, as defined in Equation XV;
   X-hat_{N}=hypothetical or simulated high-resolution image for the Nth color plane in the reference projector frame buffer 120, as defined in Equation XV; and
   N=number of color planes.

If the simulated high-resolution image 406 (X-hat) in the reference projector frame buffer 120 is identical to a given (desired) high-resolution image 408 (X), the system of component low-resolution projectors 112 would be equivalent to a hypothetical high-resolution projector placed at the same location as the reference projector 118 and sharing its optical path. In one embodiment, the desired high-resolution images 408 are the high-resolution image frames 106 (FIG. 5) received by sub-frame generator 108.

In one embodiment, the deviation of the simulated high-resolution image 406 (X-hat) from the desired high-resolution image 408 (X) is modeled as shown in the following Equation XVII:

X=\hat{X}+η Equation XVII
where:
   X=desired high-resolution frame 408;
   X-hat=hypothetical or simulated high-resolution frame 406 in the reference projector frame buffer 120; and
   η=error or noise term.

As shown in Equation XVII, the desired high-resolution image 408 (X) is defined as the simulated high-resolution image 406 (X-hat) plus η, which in one embodiment represents zero mean white Gaussian noise.

The solution for the optimal sub-frame data (Yᵢₖ*) for the sub-frames 110 is formulated as the optimization given in the following Equation XVIII:

$${Y}_{ik}^{*} = {arg max}_{{Y}_{ik}} P ( \hat{X} \vert X ) \qquad Equation XVIII$$

where:
   k=index for identifying individual sub-frames 110;
   i=index for identifying color planes;
   Yᵢₖ*=optimum low-resolution sub-frame data for the kth sub-frame 110 in the ith color plane;
   Yᵢₖ=kth low-resolution sub-frame 110 in the ith color plane;
   X-hat=hypothetical or simulated high-resolution frame 406 in the reference projector frame buffer 120, as defined in Equation XVI;
   X=desired high-resolution frame 408; and
   P(X-hat|X)=probability of X-hat given X.

Thus, as indicated by Equation XVIII, the goal of the optimization is to determine the sub-frame values (Yᵢₖ) that maximize the probability of X-hat given X. Given a desired high-resolution image 408 (X) to be projected, sub-frame generator 108 (FIG. 5) determines the component sub-frames 110 that maximize the probability that the simulated high-resolution image 406 (X-hat) is the same as or matches the “true” high-resolution image 408 (X).

Using Bayes rule, the probability P(X-hat|X) in Equation XVIII can be written as shown in the following Equation XIX:

$$P ( \hat{X} \vert X ) = \frac{P ( X \vert \hat{X} ) P ( \hat{X} )}{P ( X )} \qquad Equation XIX$$

where:
   X-hat=hypothetical or simulated high-resolution frame 406 in the reference projector frame buffer 120, as defined in Equation XVI;
   X=desired high-resolution frame 408;
   P(X-hat|X)=probability of X-hat given X;
   P(X|X-hat)=probability of X given X-hat;
   P(X-hat)=prior probability of X-hat; and
   P(X)=prior probability of X.

The term P(X) in Equation XIX is a known constant. If X-hat is given, then, referring to Equation XVII, X depends only on the noise term, η, which is Gaussian. Thus, the term P(X|X-hat) in Equation XIX will have a Gaussian form as shown in the following Equation XX:

$$P ( X \vert \hat{X} ) = \frac{1}{C} {e}^{- {\sum }_{i}^{ } \frac{( {‖ {X}_{i} - {\hat{X}}_{i} ‖}^{2} )}{2 {σ}_{i}^{2}}} \qquad Equation XX$$

where:
   X-hat=hypothetical or simulated high-resolution frame 406 in the reference projector frame buffer 120, as defined in Equation XVI;
   X=desired high-resolution frame 408;
   P(X|X-hat)=probability of X given X-hat;
   C=normalization constant;
   i=index for identifying color planes;
   Xᵢ=ith color plane of the desired high-resolution frame 408;
   X-hatᵢ=hypothetical or simulated high-resolution image for the ith color plane in the reference projector frame buffer 120, as defined in Equation II; and
   σᵢ=variance of the noise term, η, for the ith color plane.

To provide a solution that is robust to minor calibration errors and noise, a “smoothness” requirement is imposed on X-hat. In other words, it is assumed that good simulated images 406 have certain properties. For example, for most good color images, the luminance and chrominance derivatives are related by a certain value. In one embodiment, a smoothness requirement is imposed on the luminance and chrominance of the X-hat image based on a “Hel-Or” color prior model, which is a conventional color model known to those of ordinary skill in the art. The smoothness requirement according to one embodiment is expressed in terms of a desired probability distribution for X-hat given by the following Equation XXI:

$$P ( \hat{X} ) = \frac{1}{Z ( α , β )} {e}^{- \{ {α}^{2} ( {‖ ∇ {\hat{C}}_{1} ‖}^{2} + {‖ ∇ {\hat{C}}_{2} ‖}^{2} ) + {β}^{2} ( {‖ ∇ \hat{L} ‖}^{2} ) \}} \qquad Equation XXI$$

where:
   P(X-hat)=prior probability of X-hat;
   α and β=smoothing constants;
   Z(α, β)=normalization function;
   ∇=gradient operator; and
   C-hat₁=first chrominance channel of X-hat;
   C-hat₂=second chrominance channel of X-hat; and
   L-hat=luminance of X-hat.

In another embodiment, the smoothness requirement is based on a prior Laplacian model, and is expressed in terms of a probability distribution for X-hat given by the following Equation XXII:

$$P ( \hat{X} ) = \frac{1}{Z ( α , β )} {e}^{- \{ α ( \vert ∇ {\hat{C}}_{1} \vert + \vert ∇ {\hat{C}}_{2} \vert ) + β ( \vert ∇ \hat{L} \vert ) \}} \qquad Equation XXII$$

where:
   P(X-hat)=prior probability of X-hat;
   α and β=smoothing constants;
   Z(α, ≈)=normalization function;
   ∇=gradient operator; and
   C-hat₁=first chrominance channel of X-hat;
   C-hat₂=second chrominance channel of X-hat; and
   L-hat=luminance of X-hat.

The following discussion assumes that the probability distribution given in Equation XXI, rather than Equation XXII, is being used. As will be understood by persons of ordinary skill in the art, a similar procedure would be followed if Equation XXII were used. Inserting the probability distributions from Equations VII and VIII into Equation XIX, and inserting the result into Equation XVIII, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation XVIII is transformed into a function minimization problem, as shown in the following Equation XXIII:

$${Y}_{ik}^{*} = {arg min}_{{Y}_{ik}} {\sum }_{i = 1}^{N} {‖ {X}_{i} - {\hat{X}}_{i} ‖}^{2} + {α}^{2} \{ {‖ ∇ ( {\sum }_{i = 1}^{N} {T}_{{C}_{1} i} {\hat{X}}_{i} ) ‖}^{2} + {‖ ∇ ( {\sum }_{i = 1}^{N} {T}_{{C}_{2} i} {\hat{X}}_{i} ) ‖}^{2} \} + {β}^{2} {‖ ∇ ( {\sum }_{i = 1}^{N} {T}_{Li} {\hat{X}}_{i} ) ‖}^{2} \qquad Equation XIII$$

where:
   k=index for identifying individual sub-frames 110;
   i=index for identifying color planes;
   Yᵢₖ*=optimum low-resolution sub-frame data for the kth sub-frame 110 in the ith color plane;
   Yᵢₖ=kth low-resolution sub-frame 110 in the ith color plane;
   N=number of color planes;
   Xᵢ=ith color plane of the desired high-resolution frame 408;
   X-hatᵢ=hypothetical or simulated high-resolution image for the ith color plane in the reference projector frame buffer 120, as defined in Equation XV;
   α and β=smoothing constants;
   ∇=gradient operator;
   T_{C1i}=ith element in the second row in a color transformation matrix, T, for transforming the first chrominance channel of X-hat;
   T_{C2i}=ith element in the third row in a color transformation matrix, T, for transforming the second chrominance channel of X-hat; and
   T_{Li}=ith element in the first row in a color transformation matrix, T, for transforming the luminance of X-hat.

The function minimization problem given in Equation XXIII is solved by substituting the definition of X-hatᵢ from Equation XV into Equation XXIII and taking the derivative with respect to Yᵢₖ, which results in an iterative algorithm given by the following Equation XXIV:

$${Y}_{ik}^{( n + 1 )} = {Y}_{ik}^{( n )} - Θ \{ {D}_{i} {F}_{ik}^{T} {H}_{i}^{T} [ ( {\hat{X}}_{i}^{( n )} - {X}_{i} ) + {α}^{2} {∇}^{2} ( {T}_{{C}_{1} i} {\sum }_{j = 1}^{N} {T}_{{C}_{1} j} {\hat{X}}_{j}^{( n )} + {T}_{{C}_{2} i} {\sum }_{j = 1}^{N} {T}_{{C}_{2} j} {\hat{X}}_{j}^{( n )} ) … + {β}^{2} {∇}^{2} {T}_{Li} {\sum }_{j = 1}^{N} {T}_{Lj} {\hat{X}}_{j}^{( n )} ] \} \qquad Equation XXIV$$

where:
   k=index for identifying individual sub-frames 110;
   i and j=indices for identifying color planes;
   n=index for identifying iterations;
   Yᵢₖ⁽ⁿ⁺¹⁾=kth low-resolution sub-frame 110 in the ith color plane for iteration number n+1;
   Yᵢₖ⁽ⁿ⁾=kth low-resolution sub-frame 110 in the ith color plane for iteration number n;
   Θ=momentum parameter indicating the fraction of error to be incorporated at each iteration;
   Dᵢ=down-sampling matrix for the ith color plane;
   Hᵢ^{T}=Transpose of interpolating filter, Hᵢ, from Equation XIV (in the image domain, Hᵢ^{T} is a flipped version of Hᵢ);
   Fᵢₖ^{T}=Transpose of operator, Fᵢₖ, from Equation XV (in the image domain, Fᵢₖ^{T} is the inverse of the warp denoted by Fᵢₖ);
X-hatᵢ⁽ⁿ⁾=hypothetical or simulated high-resolution image for the ith color plane in the reference projector frame buffer 120, as defined in Equation XV, for iteration number n;
   Xᵢ=ith color plane of the desired high-resolution frame 408;
   α and β=smoothing constants;
   ∇²=Laplacian operator;
   T_{C1i}=ith element in the second row in a color transformation matrix, T, for transforming the first chrominance channel of X-hat;
   T_{C2i}=ith element in the third row in a color transformation matrix, T, for transforming the second chrominance channel of X-hat;
   T_{Li}=ith element in the first row in a color transformation matrix, T, for transforming the luminance of X-hat;
   X-hatⱼ⁽ⁿ⁾=hypothetical or simulated high-resolution image for the jth color plane in the reference projector frame buffer 120, as defined in Equation XV, for iteration number n;
   T_{C1j}=jth element in the second row in a color transformation matrix, T, for transforming the first chrominance channel of X-hat;
   T_{C2j}=jth element in the third row in a color transformation matrix, T, for transforming the second chrominance channel of X-hat;
   T_{Lj}=jth element in the first row in a color transformation matrix, T, for transforming the luminance of X-hat; and
   N=number of color planes.

Equation XXIV may be intuitively understood as an iterative process of computing an error in the reference projector 118 coordinate system and projecting it back onto the sub-frame data. In one embodiment, sub-frame generator 108 (FIG. 5) is configured to generate sub-frames 110 in real-time using Equation XXIV. The generated sub-frames 110 are optimal in one embodiment because they maximize the probability that the simulated high-resolution image 406 (X-hat) is the same as the desired high-resolution image 408 (X), and they minimize the error between the simulated high-resolution image 406 and the desired high-resolution image 408. Equation XXIV can be implemented very efficiently with conventional image processing operations (e.g., transformations, down-sampling, and filtering). The iterative algorithm given by Equation XXIV converges rapidly in a few iterations and is very efficient in terms of memory and computation (e.g., a single iteration uses two rows in memory; and multiple iterations may also be rolled into a single step). The iterative algorithm given by Equation XXIV is suitable for real-time implementation, and may be used to generate optimal sub-frames 110 at video rates, for example.

To begin the iterative algorithm defined in Equation XXIV, an initial guess, Yᵢₖ⁽⁰⁾, for the sub-frames 110 is determined. In one embodiment, the initial guess for the sub-frames 110 is determined by texture mapping the desired high-resolution frame 408 onto the sub-frames 110. In one embodiment, the initial guess is determined from the following Equation XXV:

Yᵢₖ⁽⁰⁾=DᵢBᵢFᵢₖ^{T}Xᵢ Equation XXV
where:
   k=index for identifying individual sub-frames 110;
   i=index for identifying color planes;
   Yᵢₖ⁽⁰⁾=initial guess at the sub-frame data for the kth sub-frame 110 for the ith color plane;
   Dᵢ=down-sampling matrix for the ith color plane;
   Bᵢ=interpolation filter for the ith color plane;
   Fᵢₖ^{T}=Transpose of operator, Fᵢₖ, from Equation XV (in the image domain, Fᵢₖ^{T} is the inverse of the warp denoted by Fᵢₖ); and
   Xᵢ=ith color plane of the desired high-resolution frame 408.

Thus, as indicated by Equation XXV, the initial guess (Yᵢₖ⁽⁰⁾) is determined by performing a geometric transformation (Fᵢₖ^{T}) on the ith color plane of the desired high-resolution frame 408 (Xᵢ), and filtering (Bᵢ) and down-sampling (Dᵢ) the result. The particular combination of neighboring pixels from the desired high-resolution frame 408 that are used in generating the initial guess (Yᵢₖ⁽⁰⁾) will depend on the selected filter kernel for the interpolation filter (Bᵢ).

In another embodiment, the initial guess, Yᵢₖ⁽⁰⁾, for the sub-frames 110 is determined from the following Equation XXVI:

Yᵢₖ⁽⁰⁾DᵢFᵢₖ^{T}Xᵢ Equation XXVI
where:
   k=index for identifying individual sub-frames 110;
   i=index for identifying color planes;
   Yᵢₖ⁽⁰⁾=initial guess at the sub-frame data for the kth sub-frame 110 for the ith color plane;
   Dᵢ=down-sampling matrix for the ith color plane;
   Fᵢₖ^{T}=Transpose of operator, Fᵢₖ, from Equation XV (in the image domain, Fᵢₖ^{T} is the inverse of the warp denoted by Fᵢₖ); and
   Xᵢ=ith color plane of the desired high-resolution frame 408.

Equation XXVI is the same as Equation XXV, except that the interpolation filter (Bₖ) is not used.

Several techniques are available to determine the geometric mapping (Fᵢₖ) between each projector 112 and the reference projector 118, including manually establishing the mappings, or using camera 122 and calibration unit 124 (FIG. 5) to automatically determine the mappings. In one embodiment, if camera 122 and calibration unit 124 are used, the geometric mappings between each projector 112 and the camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a rendering engine 22F with two projectors 112(1) and 112(2), assuming the first projector 112(1) is the reference projector 118, the geometric mapping of the second projector 112(2) to the first (reference) projector 112(1) can be determined as shown in the following Equation XXVII:

F₂=T₂T⁻¹ Equation XXVII
where:
   F₂=operator that maps a low-resolution sub-frame 110 of the second projector 112(2) to the first (reference) projector 112(1);
   T₁=geometric mapping between the first projector 112(1) and the camera 122; and
   T₂=geometric mapping between the second projector 112(2) and the camera 122.

In one embodiment, the geometric mappings (Fᵢₖ) are determined once by calibration unit 124, and provided to sub-frame generator 108. In another embodiment, calibration unit 124 continually determines (e.g., once per frame 106) the geometric mappings (Fᵢₖ), and continually provides updated values for the mappings to sub-frame generator 108.

One form of the single color projector embodiments provides a rendering engine 22F with multiple overlapped low-resolution projectors 112 coupled with an efficient real-time (e.g., video rates) image processing algorithm for generating sub-frames 110. In one embodiment, multiple low-resolution, low-cost projectors 112 are used to produce high resolution images at high lumen levels, but at lower cost than existing high-resolution projection systems, such as a single, high-resolution, high-output projector. One embodiment provides a scalable rendering engine 22F that can provide virtually any desired resolution, brightness, and color, by adding any desired number of component projectors 112 to rendering engine 22F.

In some existing display systems, multiple low-resolution images are displayed with temporal and sub-pixel spatial offsets to enhance resolution. There are some important differences between these existing systems and the single color projector embodiments. For example, in one embodiment, there is no need for circuitry to offset the projected sub-frames 110 temporally. In one embodiment, the sub-frames 110 from the component projectors 112 are projected “in-sync”. As another example, unlike some existing systems where all of the sub-frames go through the same optics and the shifts between sub-frames are all simple translational shifts, in one embodiment, the sub-frames 110 are projected through the different optics of the multiple individual projectors 112. In one form of the single color projector embodiments, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment of the single color projector embodiments, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one embodiment described herein utilizes an optimal real-time sub-frame generation algorithm that explicitly accounts for arbitrary relative geometric distortion (not limited to homographies) between the component projectors 112, including distortions that occur due to a display surface 116 that is non-planar or has surface non-uniformities. One form of the single color projector embodiments generates sub-frames 110 based on a geometric relationship between a hypothetical high-resolution reference projector 118 at any arbitrary location and each of the actual low-resolution projectors 112, which may also be positioned at any arbitrary location.

One form of the single color projector embodiments provides a rendering engine 22F with multiple overlapped low-resolution projectors 112, with each projector 112 projecting a different colorant to compose a full color high-resolution unwarped reproduction 30F on display surface 116 with minimal color artifacts due to the overlapped projection. By imposing a color-prior model via a Bayesian approach as is done in one embodiment, the generated solution for determining sub-frame values minimizes color aliasing artifacts and is robust to small modeling errors.

Using multiple off the shelf projectors 112 in rendering engine 22F allows for high resolution. However, if the projectors 112 include a color wheel, which is common in existing projectors, rendering engine 22F may suffer from light loss, sequential color artifacts, poor color fidelity, reduced bit-depth, and a significant tradeoff in bit depth to add new colors. One embodiment eliminates the need for a color wheel, and uses in its place, a different color filter for each projector 112 as shown in FIG. 10. Thus, in one embodiment, projectors 112 each project different single-color images. By not using a color wheel, segment loss at the color wheel is eliminated, which could be up to a 20% loss in efficiency in single chip projectors. One form of the single color projector embodiments increases perceived resolution, eliminates sequential color artifacts, improves color fidelity since no spatial or temporal dither is required, provides a high bit-depth per color, and allows for high-fidelity color.

Rendering engine 22F is also very efficient from a processing perspective since, in one embodiment, each projector 112 only processes one color plane. For example, each projector 112 reads and renders only one-fourth (for RGBY) of the full color data in one embodiment.

In one embodiment, rendering engine 22F is configured to project images that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment, a first plurality of the projectors 112 may be used to produce any desired brightness for the first image (e.g., left eye image), and a second plurality of the projectors 112 may be used to produce any desired brightness for the second image (e.g., right eye image). In another embodiment, rendering engine 22F may be combined or used with other display systems or display techniques, such as tiled displays.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A rendering engine comprising:
a first component configured to render warped content that is generated remotely from the rendering engine by applying a warping transformation to stored content according to warping information; and
a second component configured to inversely warp the rendered warped content according to inverse warping information that corresponds to the warping information to form a reproduction of the stored content;
wherein the second component is configured to inversely warp the rendered warped content subsequent to or contemporaneous with the warped content being rendered by the first component.

2. The rendering engine of claim 1 wherein the stored content includes plaintext content.

3. The rendering engine of claim 1 wherein the first component is configured to render the warped content by displaying the warped content onto a display surface.

4. The rendering engine of claim 3 wherein the second component includes the display surface, and wherein the display surface is distorted in accordance with the inverse warping information.

5. The rendering engine of claim 3 wherein the second component includes a lens that is distorted in accordance with the inverse warping information, and wherein the wherein the first component is configured to projecting the warped content through the lens and onto the display surface.

6. The rendering engine of claim 3 wherein the warped content is generated using non-uniform gain factors, wherein the second component includes the display surface, and wherein the display surface is configured to compensate for the non-uniform gain factors in accordance with the inverse warping information.

7. The rendering engine of claim 3 wherein the second component includes an ambient light source that is configured to inversely warp the rendered warped content on the display surface.

8. The rendering engine of claim 1 wherein the first component includes an audio player configured to render the warped content by creating an audio signal corresponding to the warped content, and wherein the second component is configured to inversely warp the audio signal as a function of time indicated by the inverse warping information.

9. The rendering engine of claim 1 wherein the first component includes an audio player configured to render the warped content by creating an audio signal corresponding to the warped content, and wherein the second component is configured to inversely warp the audio signal as a function of amplitude indicated by the inverse warping information.

10. A method performed by a processing system, the method comprising:
accessing stored content and warping information that corresponds to an inverse warping component in a first rendering engine; and
generating warped content from the stored content and warping information such that the warped content is usable by the first rendering engine to reproduce the stored content without distortion only in combination with the inverse warping component and is usable by a second rendering engine without the inverse warping component to reproduce the stored content with distortion from the warping information.

11. The method of claim 10 further comprising:
generating the warping information from inverse warping information corresponding to the inverse warping component in the first rendering engine.

12. The method of claim 10 further comprising:
generating inverse warping information corresponding to the warping information such that the inverse warping information is usable by the first rendering engine to configure the inverse warping component; and
providing the inverse warping information to the first rendering engine.

13. The method of claim 10 further comprising:
generating the warped content by visually distorting the stored content such that the warped content is usable by the second rendering engine to reproduce the stored content with visual distortion.

14. The method of claim 10 further comprising:
generating the warped content by acoustically distorting the stored content such that the warped content is usable by the second rendering engine to reproduce the stored content with acoustic distortion.

15. The method of claim 10 wherein the warping information corresponds to a configuration of a non-uniform display surface of the first rendering engine, and wherein the warping information is configured to warp the stored content such that a reproduction of the stored content appears properly when projected onto the display surface.

16. The method of claim 10 wherein the warping information corresponds to a configuration of a lens of a projector in the first rendering engine, and wherein the warping information is configured to warp the stored content such that a reproduction of the stored content appears properly when projected through the lens.

17. An image display system comprising:
a sub-frame generator configured to generate first and second sub-frames from warped content that is generated from stored content remotely from the sub-frame generator;
first and second projectors configured to simultaneously project the first and the second sub-frames, respectively, in at least partially overlapping positions to form an image on a display surface; and
an inverse warping component configured to inversely warp the first and the second sub-frames subsequent to or contemporaneous with being projected by the first and the second projectors such that the image reproduces the stored content on the display surface.

18. The image display system of claim 17 wherein the display surface includes a non-uniform surface that forms the inverse warping component.

19. The image display system of claim 18 wherein the non-uniform surface is configured according to inverse warping information that corresponds to warping information used to generate the warped content.

20. The image display system of claim 17 wherein the first and the second projectors include first and second lenses, respectively, that form the inverse warping component.
